(19) United States
(12) Patent Application Publication
(10) Pub. No.: US 2015/0207181 A1
(43) Pub. Date: Jul. 23, 2015

(54) Housing for a Battery Cell with a Housing Cover having Monitoring Electronics, Battery Cell, Battery Module, and Vehicle

(71) Applicants: Robert Bosch GmbH, Stuttgart (DE); Samsung SDI Co., Ltd., Yongin-si, Gyeonggi-do (KR)

(72) Inventor: Holger Fink, Stuttgart (DE)

(21) Appl. No.: 14/420,827

(22) PCT Filed: Jul. 1, 2013
(86) PCT No.: PCT/EP2013/063792

§ 371 Date: Feb. 10, 2015

(30) Foreign Application Priority Data
Aug. 10, 2012 (DE) 10 2012 214 230.4

(51) Int. Cl. H01M 10/42; H01M 10/48; H01M 10/0525

(52) U.S. Cl. CPC H01M 10/425; H01M 10/0525; H01M 10/48; H01M 2220/20; H01M 2010/4271

(57) ABSTRACT

A housing for a battery cell, preferably for a lithium-ion cell, includes a housing cover, and a metal-core printed circuit board on the housing cover. The housing further includes an electronic component that is configured to monitor the battery cell, and that is arranged on the metal-core printed circuit board on the housing cover. This configuration enables the temperature of the battery cell to be very precisely and cost-effectively determined by very good thermal coupling to the housing cover. The disclosure further relates to a battery cell, a battery module and a vehicle.

The present invention relates to a housing for a battery cell having a housing cover, and said invention relates to a battery cell, a battery module and a vehicle.

### PRIOR ART

It is becoming apparent that in future more and more new battery systems are being used both in the case of stationary applications, by way of example wind turbines, and also in vehicles, by way of example in hybrid vehicles and electric vehicles. Within the scope of this description, the terms ‘battery’ and ‘battery system’ are used synonymously for a ‘rechargeable battery’ and accordingly a ‘rechargeable battery system’.

Lithium ion batteries are preferably used for the mentioned applications. Lithium ion battery cells are however very susceptible to the penetration of moisture since hydrolysis can cause hydrogen fluoride to form.

Due to the required long serviceable life of over 10 years and longer, it is preferred to use in vehicles cells that have a solid housing, so-called hard case cells. Said cells comprise a housing for receiving the electrochemical elements (cell can) and a housing cover (cap plate) that seals the housing. The two components are by way of example connected to one another by means of a welding process. The battery housing is based generally on a metal material, it can comprise by way of example aluminum. The housing cover comprises at least a metal plate on the upper face of which are located the two terminals. One of the terminals is electrically isolated from the housing.

In order to be able to operate lithium ion battery cells in a safe manner, it is necessary in accordance with the prior art to provide a battery management system (BMS). The battery management system prevents inter alia the cells being overcharged or greatly discharged, a loading of the cells with an inadmissibly high charge or discharge currents. For battery systems that are used in electric vehicles or hybrid vehicles, it is necessary due to the high number of battery cells that are installed in batteries of this type to provide complex electronics for the battery management system.

So-called CSC (cell supervision circuit) electronic modules are used for monitoring the battery cells and said electronic modules monitor multiple battery cells. These electronic modules are either placed in the proximity of the associated battery cells as a “decentralized satellite” or the entire electronic system is provided in a “central electronics assembly”.

DE 20207721 U1 discloses a vehicle battery that comprises a housing having a housing cover on which components for a control system are arranged.

### DISCLOSURE OF THE INVENTION

In accordance with the invention, a housing (hard case) is provided for a battery cell, said housing having a metal housing cover, wherein an electronic component is arranged on a metal core circuit board on the housing cover.

The electronic component can be adhered to the metal core circuit board on the housing cover or the metal core circuit board is part of the metal housing cover.

It is preferred that two terminals are embodied on the surface of the housing cover, wherein the electric component is arranged between the two terminals.

The electronic component is preferably a circuit for monitoring a battery cell, a so-called CSC (cell supervision circuit), by way of example for detecting voltage and temperature.

This component is preferably part of a battery management system, preferably in a motor vehicle.

It is known to the person skilled in the art from the prior art to select the materials and to produce circuit boards on a metal substrate, so-called metal core printed circuit boards (MCPCB).

Generally, epoxy-glass fiber fabric (FR4) circuit boards are applied by way of a dielectric layer—mostly an electric isolating but good thermally conductive adhesive—to a metal substrate of aluminum or copper.

This circuit board technology has the advantage that in comparison to standard circuit boards very low thermal transfer resistances can be achieved. Therefore, this technology is used in applications where the electronic components are operated with greater power loss or in applications where the output capacity of the components being used decreases at the temperature increases.

It is preferred that the cell housing comprises metal, particularly preferred are aluminum or stainless steel.

Battery cells preferably lithium ion cells that comprise an above-described cell housing and a battery module that is constructed from these battery cells are claimed in accordance with the invention.

The arrangement of directly attaching a monitoring electronic system for a battery cell on the housing cover has the following advantages:
Since the monitoring electronic system is coupled to the housing cover in a very good thermally conductive manner, the temperature of the battery can be detected very precisely and in a cost-effective manner.
It is not necessary to mechanically attach the monitoring electronic system separately since said monitoring electronic system is connected to the housing cover in a mechanically robust manner.
The monitoring electronic system is permanently connected to a specific battery cell so that relevant operating data that have a significant influence on the aging of a battery cell can be recorded. This is on the one hand of advantage for the guarantee, on the other hand this information can also be used for a so-called “second life”, in other words recycling in another application. This is a significant advantage in particular on the basis that vehicle manufacturers nowadays are already demanding defect liability periods of 10 years and longer from the battery cell manufacturers.

The arrangement of attaching the electronic system to the housing cover is suitable for using cells in battery modules where the cells are combined with one another in an interference fit assembly over the large surface area of the end face. In order to increase their serviceable life, battery modules of this type are then used in particular if the battery cells are prevented by mechanical stress from expanding mechanically in the case of charging and discharging procedures, the mechanical stress that is generated as a result would accelerate the aging of the cells. The arrangement of attaching the electronic system to the housing cover is also suitable for an air-cooled battery system, wherein the cells are cooled by way of an air current. In this case, the cells are not pressed directly against one another but rather are assembled with the aid of distance pieces so that the air current can flow between the cells.

The subject of the invention is in addition a motor vehicle having an electric drive motor for driving the motor vehicle and a battery module that is connected or can be connected to the electric drive motor.

Advantageous further developments of the invention are disclosed in the subordinate claims and described in the description.

### DRAWINGS

An exemplary embodiment of the invention is further explained with the aid of a drawing and the description hereinunder. In the drawing:

FIG. 1 illustrates a perspective view of a battery cell in accordance with the invention.

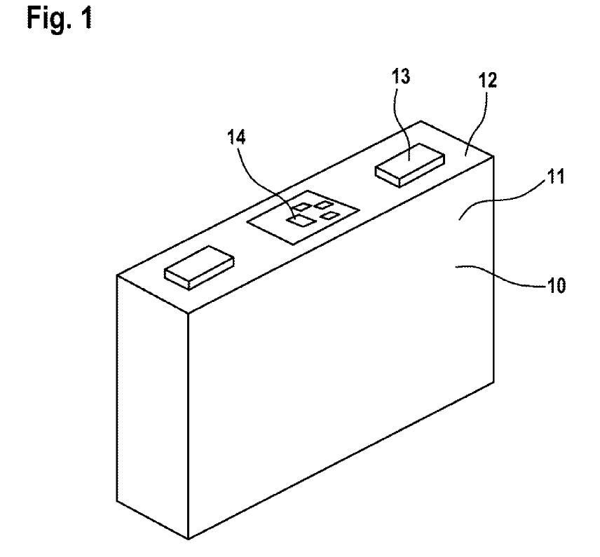

The illustrated prismatic battery cell 10 comprises a housing 11 having a housing cover 12. The housing 11 is welded to the housing cover 12 and preferably comprises aluminum or stainless steel. Two terminals 13 are embodied on the upper face of the battery cell 10 and an electronic component 14 for monitoring the battery cell 10 is arranged between said terminals. The electronic component 14 is embodied on a metal core circuit board that is not illustrated separately in the figure and is arranged on the housing cover 12.

1. A housing for a battery cell comprising:
a housing cover;
a metal core circuit board positioned on the housing cover; and
an electronic component arranged on the metal core circuit board on the housing cover.

2. The housing as claimed in claim 1, wherein the housing cover forms the metal core of the metal core circuit board.

3. The housing as claimed in claim 1, wherein:
the housing cover includes a surface having two terminals; and
the electronic component is arranged between said two terminals.

4. The housing as claimed in claims 1, wherein the electronic component includes a circuit that is configured to monitor a battery cell that is arranged in the housing.

5. The housing as claimed in, claim 1, wherein the electronic component is part of a battery management system.

6. A battery cell comprising;
a housing that includes:
a housing cover;
a metal core circuit board positioned on the housing cover; and
an electronic component arranged on the metal core circuit board on the housing cover.

7. The battery cell as claimed in claim 6, wherein the battery cell is a lithium ion cell.

8. The battery cell as claimed in claim 7, wherein the battery cell is comprised by a battery module.

9. A motor vehicle comprising:
an electric drive motor; and
a battery module that is connected or is configured to be connected to the electric drive motor, and that includes:
a battery cell having:.
a housing with:
a housing cover;
a metal core circuit board positioned on the housing cover; and
an electronic component arranged on the metal core circuit board on the housing cover.
